(19) United States
(12) Patent Application Publication
(10) Pub. No.: US 2021/0242698 A1
(43) Pub. Date: Aug. 5, 2021

(54) METHOD AND ELECTRONIC DEVICE FOR REAL TIME ADAPTIVE CHARGING OF BATTERY

(71) Applicant: Samsung Electronics Co., Ltd., Suwon-si (KR)

(72) Inventors: Anshul KAUSHIK, Bangalore (IN); Aravinda Reddy MANDLI, Bangalore (IN); Ankit YADU, Bangalore (IN); Krishnan Seethalakshmy HARIHARAN, Bangalore (IN); Piyush TAGADE, Bangalore (IN); Rajkumar Subhash PATIL, Bangalore (IN); Jeonghoon JO, Suwon-si (KR)

(21) Appl. No.: 17/085,977

(22) Filed: Oct. 30, 2020

(30) Foreign Application Priority Data
Feb. 4, 2020 (IN) 202041004863

(51) Int. Cl. H02J 7/00

(52) U.S. Cl. CPC H02J 7/0048; H02J 7/007194; H02J 7/007182

(57) ABSTRACT

Embodiments herein provide a method for real time adaptive charging of a battery. The method includes receiving at least one battery parameter. Further, the method includes determining a present battery condition. Further, the method includes correcting the at least one battery parameter based on the present battery condition. Further, the method includes determining a real time optimal current used for charging the battery based on the at least one corrected battery parameter. Further, the method includes charging the battery based on the determined real time optimal current, where a battery management system configures a charger integrated circuit to charge the battery. Further, the method includes updating and storing the at least one battery parameter in real time in a memory after charging the battery at the optimal current.

### CROSS-REFERENCE TO RELATED APPLICATION

This application is based on and claims priority under 35 U.S.C. 119 to Indian Patent Application No. 202041004863 filed on Feb. 4, 2020 in the Indian Intellectual Property Office, the disclosure of which is herein incorporated by reference in its entirety.

### BACKGROUND

### 1. Field

The present disclosure relates to electric cells, and more specifically to a method and electronic device for real time adaptive charging of a battery.

### 2. Description of Related Art

A loss in a charge capacity of a battery or a battery degradation occurs after recharge cycles reduces a usable life of the battery, which causes huge customer inconvenience in future. Formation of a Solid Electrolyte Interphase (SEI) layer at an anode of the battery is one of the major reasons for the battery degradation. Existing methods are available to reduce the battery degradation by limiting the formation of the SEI layer. An existing method includes determining a charging profile for charging the battery based on a state of battery while initiating a charging process. The state of battery includes a charge capacity of the battery, a charging time to completely charge the battery, a State of Charge (SOC) of the battery, a State of Health (SOH) of the battery and, a temperature of the battery and the like. The charging profile defines an electric power used to charge the battery at each instant of time at said temperature.

However, an operating condition of the battery varies while progressing the charging of the battery in real time scenarios. In an example scenario, the temperature of the battery varies while progressing the charging of the battery. The variation in the temperature causes to change the charging time to completely charge the battery. Moreover, the variation in the temperature causes to change the charge capacity of the battery. When the battery is charging with said charging profile without accounting the variation in the state of the battery, the battery either gets over charged or partially charged. Overcharging tampers a health of the battery. A rate of the battery degradation increases in case of discharging a partially charged battery.

In the real time scenarios of charging the battery in an electronic device, the electronic device performs operations such as running mobile/computer applications, operating a motor, recording video and the like. The electronic device consumes an amount of electric power for these operations from the electric power supplying for charging the battery. Therefore, the battery receives less amount of power for charging within the charging time, which results in the partially charged battery. Aforementioned, the rate of the battery degradation increases in case of discharging the partially charged battery. Therefore, a real time adaptive charging method is used to effectively use the charge capacity of the battery and extend the usable life of the battery. Thus, it is desired to at least provide a useful alternative.

The principal object of the embodiments herein is to provide a method and electronic device for real time adaptive charging of a battery.

Another object of the embodiments herein is to reduce a charge capacity loss (or degradation) of the battery and extend a usable life of the battery.

Another object of the embodiments herein is to completely charge the battery within a given time using a current less than a prescribed current and a voltage less than a prescribed voltage, with a reduced charge capacity loss.

Another object of the embodiments herein is to correct a charge capacity of the battery and a time used to completely charge the battery based on a present battery condition.

Another object of the embodiments herein is to determine a real time optimal current used for charging the battery based on the present battery condition, a corrected charge capacity and a corrected time to completely charge the battery.

Another object of the embodiments herein is to adaptively update a charging profile of the battery to completely charge the battery due to a current lost occurring while charging the battery in real time scenarios.

### SUMMARY

Accordingly, the embodiments herein provide a method for real time adaptive charging of a battery. The method includes receiving, by a Battery Management System (BMS), at least one battery parameter. The method includes determining, by the BMS, a present battery condition. Further, the method includes correcting, by the BMS, the at least one battery parameter based on the present battery condition. Further, the method includes determining, by the BMS, a real time optimal current used for charging the battery based on the at least one corrected battery parameter. Further, the method includes charging, by the BMS, the battery based on the determined real time optimal current, where the BMS configures a charger Integrated Circuit (IC) to charge the battery. Further, the method includes updating and storing, by the BMS, the at least one corrected battery parameter in real time in a memory after charging the battery at the optimal current.

In an embodiment, the method further includes obtaining, by the BMS, an actual current supplied by the charger IC to charge the battery. Further, the method includes determining, by the BMS, a difference in the determined real time optimal current and the actual current supplied by the charger IC. Further, the method includes correcting, by the BMS, the at least one battery parameter based on the difference. Further, the method includes storing, by the BMS, the present battery condition and the at least one corrected battery parameter to the memory.

In an embodiment, where the present battery condition includes at least one of a charge capacity of the battery, a temperature of the battery, or a voltage of the battery.

In an embodiment, where the at least one battery parameter includes at least one of a current, a temperature of the battery, State of Charge (SOC) of the battery, State of Health (SOH) of the battery, a charge capacity of the battery, a voltage of the battery, or tunable parameters.

In an embodiment, where the BMS configures the charger IC to charge the battery based on the at least one corrected battery parameter, in response to correcting the at least one battery parameter in real time or periodically based on the difference.

Accordingly, the embodiments herein provide a method to increase a life of a battery using real time adaptive charging. The method includes receiving, by a BMS, at least one battery parameter. The method includes determining, by the BMS, a present battery condition. Further, the method includes correcting, by the BMS, the at least one battery parameter based on the present battery condition. Further, the method includes determining, by the BMS, a degradation state of the battery using a mathematical model. Further, the method includes determining, by the BMS, a real time optimal current used for charging the battery for reducing the determined degradation. Further, the method includes charging, by the BMS, the battery based on the determined real time optimal current for enhancing the life of the battery.

Accordingly, the embodiments herein provide an electronic device for real time adaptive charging of a battery. The electric device includes a memory and a BMS. The BMS is coupled to the memory. The BMS is configured to receive at least one battery parameter. The BMS is configured to determine a present battery condition. Further, the BMS is configured to correct the at least one battery parameter based on the present battery condition. Further, the BMS is configured to determine a real time optimal current used for charging the battery based on the at least one corrected battery parameter. Further, the BMS is configured to charge the battery based on the determined real time optimal current, where the BMS configures a charger IC to charge the battery. Further, the BMS is configured to update and store the battery parameters in real time after charging the battery at the optimal current.

Accordingly, the embodiments herein provide an electronic device to increase a life of a battery using real time adaptive charging. The electric device includes a memory and a BMS. The BMS is coupled to the memory. The BMS is configured to receive at least one battery parameter. The BMS is configured to determine a present battery condition. Further, the BMS is configured to correct the at least one battery parameter based on the present battery condition. Further, the BMS is configured to determine a degradation state of the battery using a mathematical model. Further, the BMS is configured to determine a real time optimal current used for charging the battery for reducing the determined degradation. Further, the BMS is configured to charge the battery based on the determined real time optimal current for enhancing the life of the battery.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device for real time adaptive charging of a battery, according to an embodiment as disclosed herein;

FIG. 2A illustrates a flow diagram of a method for the real time adaptive charging of the battery, according to an embodiment as disclosed herein;

FIG. 2B illustrates a flow diagram of a method to increase a life of the battery using the real time adaptive charging, according to an embodiment as disclosed herein;

FIG. 3 illustrates a graph of a plot of a charge capacity correction factor against a temperature of the battery, according to an embodiment as disclosed herein;

FIG. 4 illustrates a graph pf a plot of a charging time correction factor against the temperature of the battery, according to an embodiment as disclosed herein;

FIG. 5 illustrates a graph of a plot of a current supplied by a charging integrated circuit against a charging time of the battery at various charging cycle, according to an embodiment as disclosed herein;

FIG. 6 illustrates a graph of a plot of the current supplied by the charging integrated circuit against the charging time of the battery at an ideal example scenario and a real time example scenario, according to an embodiment as disclosed herein; and

FIGS. 7A-7C illustrate graphs for showing an improvement in reducing a total charge capacity loss of the battery by using the proposed method with respect to a conventional method, according to an embodiment as disclosed herein.

### DETAILED DESCRIPTION

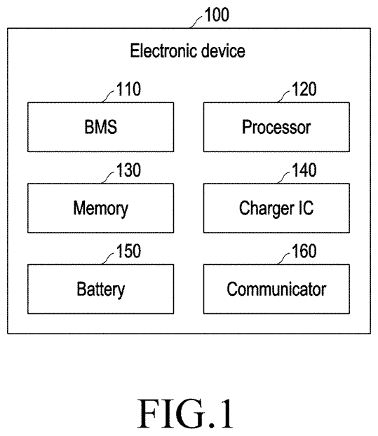

FIGS. 1 through 7C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

A model for a loss in a charge capacity of a battery is given in equation 1.

$${I}_{s e i} = {I}_{0 , sei} exp ( - \frac{{α}_{n} F}{{C}_{A} {R}_{g} T} [ {U}_{0} - {U}_{s e i} ] + {sinh}^{- 1} ( \frac{I}{2 {I}_{0}} ) ) \qquad ( 1 )$$

where, Iₛₑᵢ is a value of instantaneous side reaction rate, which is a growth rate of a Solid Electrolyte Interphase (SEI) layer. The value of Iₛₑᵢ depends on a present Open circuit potential (OCP) of an anode of the battery and a current being supplied for charging the battery. I_{0, sei} is a constant that determines a growth rate of the SEI layer, αₙ is a reaction stoichiometry (i.e. a constant used as 0.5), F is Faraday's constant, C_{A} is tunable parameter, R_{g} is universal gas constant, T is temperature, Uₒ is an anode potential, Uₛₑᵢ¹ is a thermodynamic property and a reduction potential for the SEI layer, where the Uₛₑᵢ depends on an anode material. I is the supplied current, I₀ is an exchange current density, which depends on the anode material.

A total charge capacity loss of the battery due to a growth of the SEI layer in a given charge cycle for the supplied current is given in equation 2.

Q_{Loss}=∫ₜ^{t}^{ₘₐₓ} Iₛₑᵢ dt (2)

where, tₘₐₓ is the present charging time of the battery 150, t is a present time in the charge cycle, which is 0 at a beginning stage of the charge cycle. In an example scenario, value of t in the equation 2 can be replaced by 0, for capacity loss over the full cycle.

The total charge capacity loss should be reduced with constraints on maximum current (I≤Iₘₐₓ), maximum voltage (V≤Vₘₐₓ), total charge time (t=tₘₐₓ), temperature for charging the battery at an SOC (SOC=SOCₘₐₓ), where the SOC is a level of charge of the battery 150 relative to a present charge capacity of the battery.

The charge capacity and the charging time of the battery changes with the temperature of the battery due to a change in diffusion rate constants with the temperature. The charge capacity of the battery will be higher at higher temperatures.

Accordingly, the embodiments herein provide a method for real time adaptive charging of a battery. The method includes dynamically receiving, by a Battery Management System (BMS), at least one battery parameter. The method includes determining, by the BMS, a present battery condition. Further, the method includes correcting, by the BMS, the at least one battery parameter based on the present battery condition. Further, the method includes determine, by the BMS, a real time optimal current used for charging the battery based on the at least one corrected battery parameter. Further, the method includes charging, by the BMS, the battery based on the determined real time optimal current, where the BMS configures (ex. controls or sets) a charger Integrated Circuit (IC) to charge the battery. Further, the method includes updating and storing, by the BMS, the at least one corrected battery parameter in real time in the memory after charging the battery at the optimal current.

Unlike existing methods and systems, the BMS determines the current used for charging the battery by monitoring changes in battery conditions at real time or each instant of time. Further, the BMS estimates a difference in the determined real time optimal current and the actual current supplied to the battery in real time scenarios for charging the battery. The BMS adaptively modifies a charging profile of the battery to compensate the difference in charging current and completely charge the battery within a given time. Therefore, the BMS intelligently charges the battery based on the changes in the battery conditions and the modified charging profile, which reduces the capacity loss and extends a usable life of the battery. Further, the proposed method is computationally simple and easy to adapt in mobile devices such as a smart phone, an action camera and the like

Referring now to the drawings, and more particularly to FIGS. 1 through 7C, there are shown preferred embodiments.

FIG. 1 illustrates a block diagram of an electronic device 100 for real time adaptive charging of a battery 150, according to an embodiment as disclosed herein. Examples for the electronic device 100 are, but not limited to a mobile device, a desktop computer, an Internet of Things (IoT), a multimedia device, a wearable device, a server device, an electric vehicle, an energy storage device and the like. In an embodiment, the electronic device 100 includes a Battery Management System (BMS) 110, a processor 120, a memory 130, a charger IC 140, a battery 150 and a communicator 160. The processor 120 coupled to the memory 130. The BMS is coupled to the memory 130 and the processor 120.

The processor 120 is configured to execute instructions stored in the memory 130. The memory 130 may include non-volatile storage elements. Examples of such non-volatile storage elements may include magnetic hard discs, optical discs, floppy discs, flash memories, or forms of an Electrically Programmable Memory (EPROM) or an Electrically Erasable and Programmable Memory (EEPROM). In addition, the memory 130 may, in some examples, be considered a non-transitory storage medium. The term “non-transitory” may indicate that the storage medium is not embodied in a carrier wave or a propagated signal.

However, the term “non-transitory” should not be interpreted that the memory 130 is non-movable. In some examples, the memory 130 can be configured to store larger amounts of information than the memory 130. In certain examples, a non-transitory storage medium may store data that can, over time, change (e.g., in Random Access Memory (RAM) or cache). The charger IC 140 delivers a current to the battery 150 from a charger of the electronic device 100, for charging the battery 150. In an embodiment, the battery 150 includes at least one lithium based cell for storing charge. Examples for a lithium based electric cell are a lithium ion cell, a lithium polymer cell and the like. The communicator 160 is configured to communicate internally between hardware components in the electronic device 100.

The BMS 110 is configured to receive at least one battery parameter. In an embodiment, the at least one battery parameter includes at least one of a current, a temperature of the battery 150, State of Charge (SOC) of the battery 150, State of Health (SOH) of the battery 150, a charge capacity of the battery 150, a voltage of the battery 150, or tunable parameters. In another embodiment, the at least one battery parameter includes at least one of a present charge capacity of the battery 150 or a present charging time of the battery 150. The present charge capacity of the battery 150 is the charge capacity of the battery 150 to completely charge the battery 150 at the present operating condition of the battery 150 (i.e. present battery condition). The present charging time of the battery 150 is the time taken for charging the battery 150 from 0% SOC to 100% under at the present operating condition.

Values of the tunable parameters are able to vary in small range for tuning a charging profile of the battery 150. In an example, C_{A} is a ratio of a cell voltage to an electrode potential. A value of the C_{A} is varying, which depends on the SOC. In the proposed method, the value of C_{A} is taken as a constant. In another example, tₘₐₓ is operate as the tunable parameter, where the tₘₐₓ is used to modify the battery charging faster or slower.

The BMS 110 is configured to determine the present battery condition. Examples for an operating condition are, but not limited to an ambient temperature, a battery temperature, a rate of consumption of the charge, and the like. In an embodiment, the present battery condition comprises at least one of a charge capacity of the battery 150, a temperature of the battery 150, a voltage of the battery 150, a reference charge capacity of the battery 150, or a reference charging time of the battery 150. The reference charge capacity of the battery 150 is a present standard charge capacity of the battery 150 to completely charge the the battery 150 at a standard operating condition (i.e. Temperature=25° C.).

In an embodiment, the BMS 110 is configured to compute the reference charge capacity at end of each charging cycle of the battery 150 and store the reference charge capacity to the memory 130. The reference charging time of the battery 150 is a time taken to charge the battery 150 from 0% SOC to 100% SOC at the standard operating conditions (i.e. Temperature=25° C.). In an embodiment, the BMS 110 is configured to compute the reference charging time at end of each charging cycle of the battery 150 and store the reference charging time to the memory 130. In another embodiment, a fuel gauge (not shown) of the electronic device 100 determines the battery condition continuously or periodically.

The BMS 110 is configured to correct at least one battery parameter based on the present battery condition. In an embodiment, the BMS 110 is configured to obtain a relationship between a charge capacity correction factor and the temperature of the battery 150 at each instant of time while charging the battery 150. The charge capacity correction factor is a ratio of the present charge capacity of the battery 150 and the reference charge capacity of the battery 150. In an embodiment, the BMS 110 is configured to compute the charge capacity correction factor at a beginning stage of the battery charging and update while the battery charging continues. In another embodiment, the BMS 110 is configured to obtain the relationship between the charge capacity correction factor and the temperature of the battery 150 based on a sample battery charging data of the battery 150.

The BMS 110 is configured to fetch the present battery condition stored from the memory 130, in response to detect the charging of the battery 150. Further, the BMS 110 is configured to obtain a present temperature of the battery. Further, the BMS 110 is configured to correct the present charge capacity of the battery 150 based on the present temperature of the battery and the relationship between a charge capacity correction factor and the temperature of the battery 150 at each instant of time.

In an embodiment, the BMS 110 is configured to obtain a relationship between a charging time correction factor and the temperature of the battery 150 at each instant of time while charging the battery 150. The charging time correction factor is a ratio of the present charging time of the battery 150 and the reference charging time of the battery 150. In an embodiment, the BMS 110 is configured to compute the charging time correction factor at the beginning stage of the battery charging and update while the battery charging continues. In another embodiment, the BMS 110 is configured to obtain the relationship between the charging time correction factor and the temperature of the battery 150 based on the sample battery charging data of the battery 150.

The BMS 110 is configured to fetch the reference charging time stored from the memory 130, in response to detect the charging of the battery. Further, the BMS 110 is configured to obtain the present temperature of the battery. Further, the BMS 110 is configured to correct the present charging time of the battery 150 based on the present temperature of the battery and the relationship between the charge capacity correction factor and the temperature of the battery 150 at each instant of time.

The BMS 110 is configured to determine a real time optimal current used for charging the battery 150 based on the at least one corrected battery parameter. In another embodiment, the BMS 110 is configured to determine a degradation state of the battery 150 using a mathematical model. Further, the BMS 110 is configured to determine the real time optimal current used for charging the battery 150 for reducing the determined degradation.

The BMS 110 is configured to charge the battery 150 based on the determined real time optimal current for enhancing the life of the battery 150. The BMS 110 is configured to adapt a charging profile of the battery 150 based on the determined real time optimal current. The BMS 110 configures the charger IC 140 to charge the battery 150. The BMS 110 is configured to update and store the battery parameters in real time after charging the battery 150 at the optimal current to the memory 130.

The BMS 110 is configured to obtain an actual current supplied by the charger IC 140 to charge the battery 150. The BMS 110 is configured to determine a difference in the determined real time optimal current and the actual current supplied by the charger IC 140. The BMS 110 is configured to correct the at least one battery parameter based on the difference. In an embodiment, correcting the at least one battery parameter in real time or periodically based on the difference.

In an example, the BMS 110 is configured to determine an amount of correction used to the present charging time of the battery 150 for a given SOC range based on the difference. The amount of correction used for the present charging time is given in equation 3.

$${t}^{corr} = \frac{{\int }_{{t}_{i}}^{{t}_{i} + Δ t} ( {I}_{predicted} - {I}_{FG} ) dt}{{\int }_{{t}_{i}}^{{t}_{i} + Δ t} ( {I}_{predicited} ) dt} Δ t \qquad ( 3 )$$

where, I_{predicted} is the determined real time optimal current, I_{FG} is the actual current supplied by the charger IC 140, tᵢ is a previous time instant at which the adaptive current calculation was done, and Δt is a fixed interval at which the calculation happens, where the I_{predicted} is calculated at tᵢ. In an example, value of Δt is in between 1-60 seconds. The corrected present charging time of the battery 150 is given in equation 4.

t_{new}^{target}=t_{old}^{target}+t^{corr} (4)

where, t_{old}^{target} is the the present charging time of the battery 150 determined based on the present battery condition.

In an embodiment, the amount of correction for the at least one battery parameter is computed at each charging cycle. The BMS 110 configures the charger IC 140 to charge the battery 150 based on the at least one corrected battery parameter. The BMS 110 is configured to adapt the charging profile of the battery 150 based on the at least one corrected battery parameter. The BMS 110 is configured to store the present battery condition and the at least one corrected battery parameter to the memory 130.

Although the FIG. 1 shows the hardware components of the electronic device 100 but it is to be understood that other embodiments are not limited thereon. In other embodiments, the electronic device 100 may include less or more number of components. Further, the labels or names of the components are used only for illustrative purpose and does not limit the scope of the disclosure. One or more components can be combined together to perform same or substantially similar function for the real time adaptive charging of the battery 150.

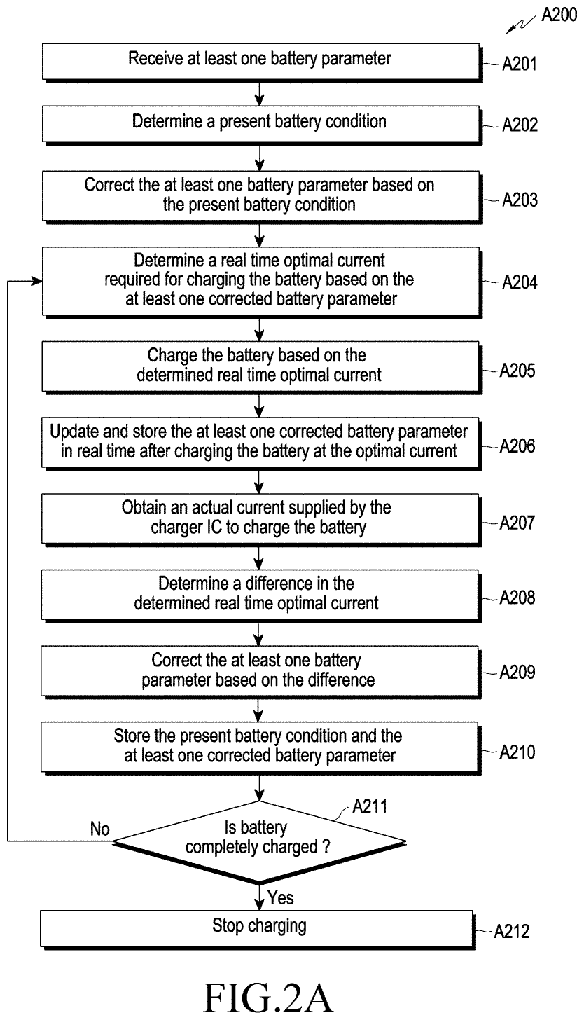

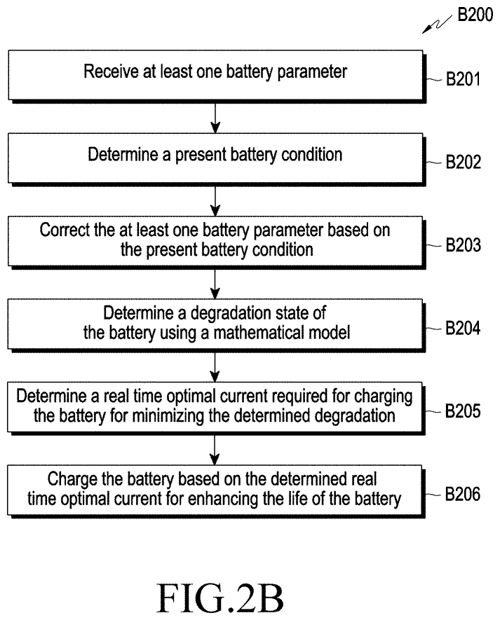

FIG. 2A illustrates a flow diagram A200 of a method for the real time adaptive charging of the battery 150, according to an embodiment as disclosed herein. At step A201, the method includes dynamically receiving the at least one battery parameter. In an embodiment, the method allows the BMS 110 to receive the at least one battery parameter. In an embodiment, the method allows the BMS 110 to dynamically receive the at least one battery parameter. At step A202, the method includes determining the present battery condition. In an embodiment, the method allows the BMS 110 to determine the present battery condition. At step A203, the method includes correcting the at least one battery parameter based on the present battery condition. In an embodiment, the method allows the BMS 110 to correct the at least one battery parameter based on the present battery condition. At step A204, the method includes determining the real time optimal current required for charging the battery 150 based on the at least one corrected battery parameter. In an embodiment, the method allows the BMS 110 to determine the real time optimal current used for charging the battery 150 based on the at least one corrected battery parameter.

At step A205, the method includes charging the battery 150 based on the determined real time optimal current. In an embodiment, the method allows the BMS 110 to charge the battery 150 based on the determined real time optimal current, where the BMS 110 configures the charger IC 140 to charge the battery 150. At step A206, the method includes updating and storing the battery parameters in real time after charging the battery 150 at the optimal current. In an embodiment, the method allows the BMS 110 to update and store the at least one corrected battery parameter in real time after charging the battery 150 in the memory 130. At step A207, the method includes obtaining the actual current supplied by the charger IC 140 to charge the battery 150. In an embodiment, the method allows the BMS 110 to obtain the actual current supplied by the charger IC 140 to charge the battery 150. At step A208, the method includes determining the difference in the determined real time optimal current and the actual current supplied by the charger IC 140. In an embodiment, the method allows the BMS 110 to determine the difference in the determined real time optimal current and the actual current supplied by the charger IC 140.

At step A209, the method includes correcting the at least one battery parameter based on the difference. In an embodiment, the method allows the BMS 110 to correct the at least one battery parameter based on the difference. At step A210, the method includes storing the present battery condition and the at least one corrected battery parameter. In an embodiment, the method allows the BMS 110 to store the present battery condition and the at least one corrected battery parameter in the memory 130. At step A211, the method includes determining whether the battery 150 is completely charged. In an embodiment, the method allows the BMS 110 to determine whether the battery 150 is completely charged. The method continues to perform from the step A204, in response to detecting that the battery 150 is not completely charged. At step A212, the method includes stopping the charging of the battery 150, in response to detecting that the battery 150 is completely charged. In an embodiment, the method allows the charger IC 140 to stop the charging of the battery 150, in response to detecting that the battery 150 is completely charged.

The various actions, acts, blocks, steps, or the like in the flow diagram A200 may be performed in the order presented, in a different order or simultaneously. Further, in some embodiments, some of the actions, acts, blocks, steps, or the like may be omitted, added, modified, skipped, or the like without departing from the scope of the disclosure.

FIG. 2B illustrates a flow diagram B200 of a method to increase the life of the battery 150 using the real time adaptive charging, according to an embodiment as disclosed herein. At step B201, the method includes receiving the at least one battery parameter. In an embodiment, the method allows the BMS 110 to dynamically receive the at least one battery parameter. At step B202, the method includes determining the present battery condition. In an embodiment, the method allows the BMS 110 to determine the present battery condition. At step B203, the method includes correcting the at least one battery parameter based on the present battery condition. In an embodiment, the method allows the BMS 110 to correct the at least one battery parameter based on the present battery condition. At step B204, the method includes determining the degradation state of the battery 150 using the mathematical model. In an embodiment, the method allows the BMS 110 to determine the degradation state of the battery 150 using the mathematical model. At step B205, the method includes determining the real time optimal current used for charging the battery 150 for reducing the determined degradation. In an embodiment, the method allows the BMS 110 to determine the real time optimal current used for charging the battery 150 for reducing the determined degradation. At step B206, the method includes charging the battery 150 based on the determined real time optimal current for enhancing the life of the battery 150. In an embodiment, the method allows the BMS 110 to charging the battery 150 based on the determined real time optimal current for enhancing the life of the battery 150.

The various actions, acts, blocks, steps, or the like in the flow diagram B200 may be performed in the order presented, in a different order or simultaneously. Further, in some embodiments, some of the actions, acts, blocks, steps, or the like may be omitted, added, modified, skipped, or the like without departing from the scope of the disclosure.

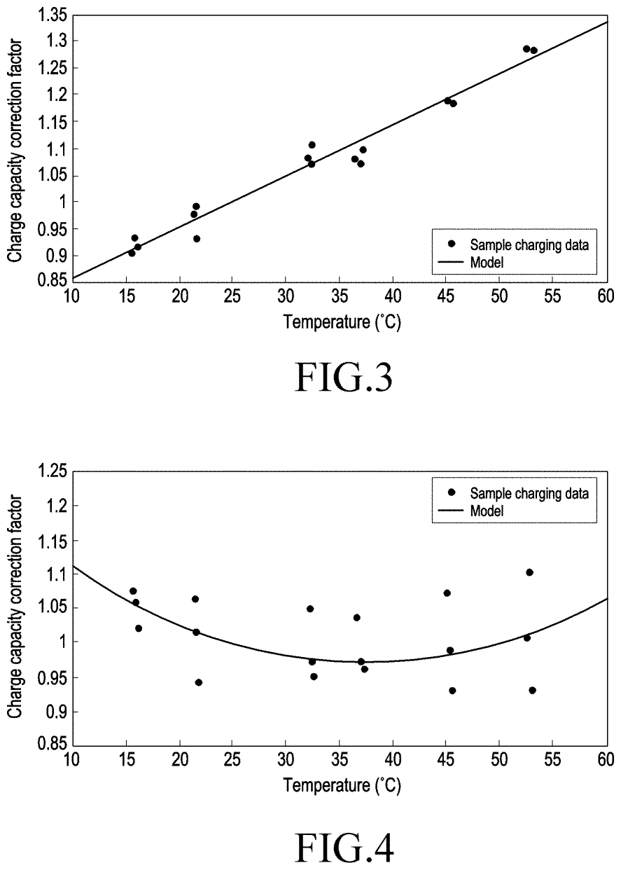

FIG. 3 illustrates a graph of a plot of the charge capacity correction factor against the temperature of the battery 150, according to an embodiment as disclosed herein. The charge capacity correction factor at various temperature of the battery 150 based on the sample charging data of the battery 150 is marked as dots in the graph in the FIG. 3. The relationship of the charge capacity correction factor at various temperature of the battery 150 is modelled as a linear function in the graph based on the marked dots. The electronic device 100 computes the present charge capacity using equation 5.

Present charge capacity=(Reference charge capacity)×(Charge capacity correction factor) (5)

The electronic device 100 computes the present charge capacity at the temperature by providing the temperature and the reference charge capacity to an equation of the linear function.

FIG. 4 illustrates a graph of a plot of a charging time correction factor against the temperature of the battery 150, according to an embodiment as disclosed herein. The charging time correction factor at various temperature of the battery 150 based on the sample charging data of the battery 150 is marked as dots in the graph in the FIG. 4. The relationship of the charging time correction factor at various temperature of the battery 150 is modelled as a non-linear function in the graph based on the marked dots. The electronic device 100 computes the present charging time using equation 6.

Present charging time=(Reference charging time)×(Charging time correction factor) (6)

The electronic device 100 computes the present charging time at the temperature by providing the temperature and the reference charge capacity to an equation of the non-linear function.

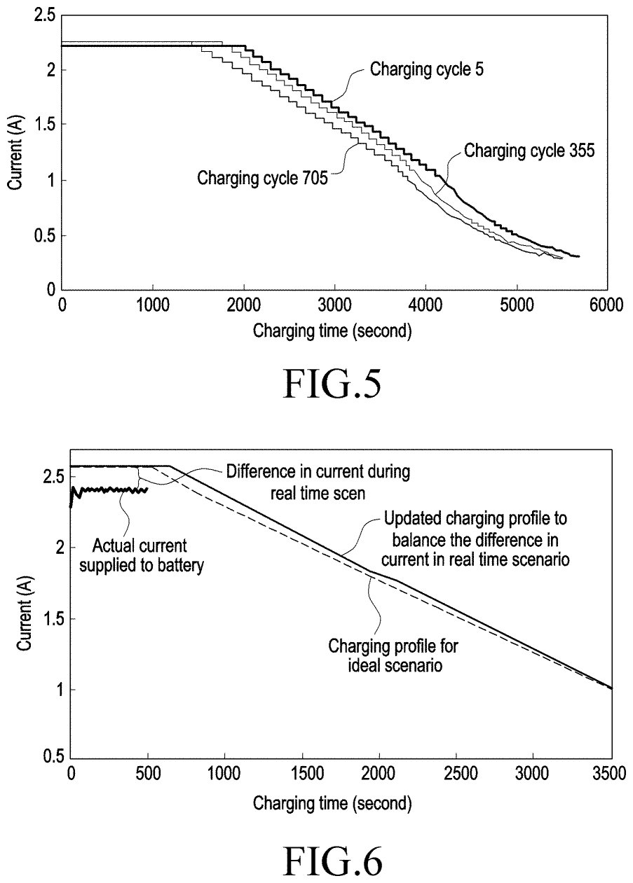

FIG. 5 illustrates a graph of a plot of a current supplied by the charging IC 140 against the charging time of the battery 150 at various charging cycle, according to an embodiment as disclosed herein. The electronic device 100 adaptively changes a charging profile of the battery 150 based on the proposed method, due to ageing of the battery 150 is shown in the graph of the FIG. 5. The charging IC 140 delivers a constant current to the battery 150 for more than 2000 seconds in the initial stage of charging cycle 5 and linearly reduces the current within the given time.

The charge capacity of the battery 150 is less at a charging cycle 355 with reference to the charging cycle 5. Therefore, the charging IC 140 delivers almost the constant current to the battery 150 for 2000 seconds in the initial stage of the charging cycle 355 and linearly reduces the current within the given time. The charge capacity of the battery 150 is less at charging cycle 705 with reference to the charging cycle 355. Therefore, the charging IC 140 delivers almost the constant current for less than 2000 seconds to the battery 150 in the initial stage of the charging cycle 355 and linearly reduces the current within the given time.

FIG. 6 illustrates a graph of a plot of the current supplied by the charging IC 140 against the charging time of the battery 150 at an ideal example scenario and a real time example scenario, according to an embodiment as disclosed herein. A charging profile for charging the battery 150 using the determined real time optimal current for the ideal example scenario is shown in the graph of the FIG. 6. Consider, the electronic device 100 sets the charging IC 140 to deliver the determined real time optimal current to the battery 150. Consider, the electronic device 100 consumes an amount of current from the determined real time optimal current for other operations in the real time example scenario. Therefore, the actual current delivering by the charging IC 140 to the battery 150 is less than the determined real time optimal current.

The electronic device 100 determines the difference in the actual current and the determined real time optimal current. Further, the electronic device 100 adaptively modifies the charging profile to balance the difference in the current in the real time example scenario as shown in the graph of the FIG. 6 for completing the charging of battery in given time. Further, the electronic device 100 supplies the actual current to the battery 150 for more time at the initial stage of the charging to compensate the amount of current lost for charging the battery 150.

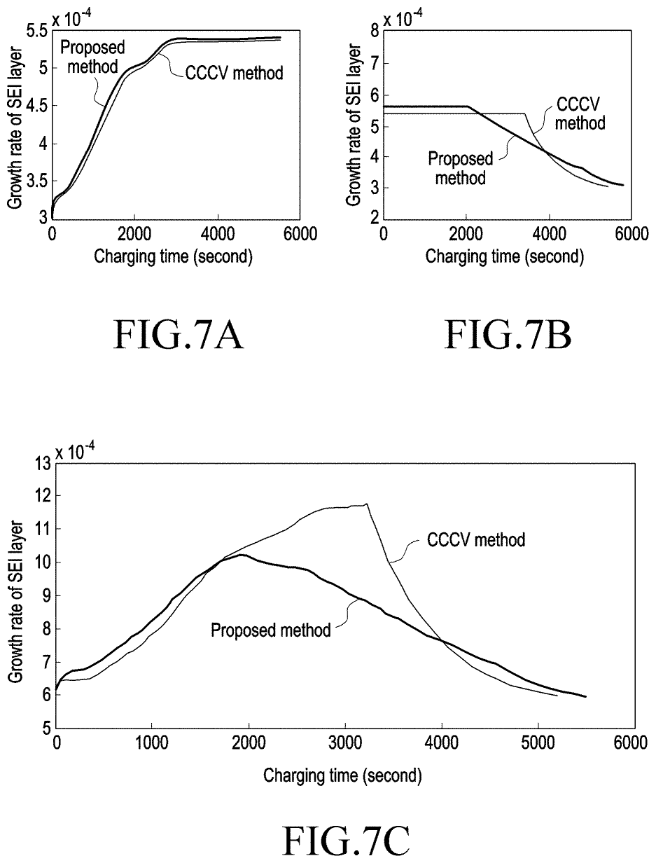

FIG. 7A-7C illustrate graphs for showing an improvement in reducing the total charge capacity loss of the battery 150 by using the proposed method with respect to a conventional method, according to an embodiment as disclosed herein. In an example scenario, Constant Current, Constant Voltage (CCCV) is the conventional method used for charging the battery 150. The growth rate of the SEI layer at the battery 150 is plotted against the charging time of the battery 150 in the graphs. Consider,

$$- \frac{{α}_{n} F}{{C}_{A} {R}_{g} T} [ {U}_{0} - {U}_{s e i} ]$$

is a first term in a model for the total charge capacity loss of the battery 150. The first term is depend to the voltage supplied to the battery 150.

As shown in the FIG. 7A, the growth rate of the SEI layer is almost same while charging the battery 150 using the CCCV method and the proposed method. Consider,

$${sinh}^{- 1} ( \frac{I}{2 {I}_{0}} )$$

is a second term in a model for the total charge capacity loss of the battery 150. The second term is depend to the current supplied to the battery 150. As shown in the FIG. 7B, the growth rate of the SEI layer is higher while charging the battery 150 using the CCCV method with respect to the proposed method.

The total charge capacity loss in a charge cycle is a product of the first term and the second term, which is an area under a curve. As shown in the FIG. 7C, the area under the curve corresponds to the proposed method is significantly less than the area under the curve corresponds to the CCCV method. When the battery charges using proposed method, the growth rate of the SEI layer is less, which improves a usable life of the battery 150.

The embodiments disclosed herein can be implemented using at least one software program running on at least one hardware device and performing network management functions to control the elements.

Although the present disclosure has been described with various embodiments, various changes and modifications may be suggested to one skilled in the art. It is intended that the present disclosure encompass such changes and modifications as fall within the scope of the appended claims.

What is claimed is:

1. A method for real time adaptive charging of a battery, the method comprises:
receiving, by a Battery Management System (BMS), at least one battery parameter;
determining, by the BMS, a present battery condition;
correcting, by the BMS, the at least one battery parameter based on the present battery condition;
determining, by the BMS, a real time optimal current used for charging the battery based on the at least one corrected battery parameter;
charging, by the BMS, the battery based on the determined real time optimal current, wherein the BMS configures a charger Integrated Circuit (IC) to charge the battery; and
updating and storing, by the BMS, the at least one corrected battery parameter in real time in a memory after charging the battery at the determined real time optimal current.

2. The method as claimed in claim 1, the method further comprises:
obtaining, by the BMS, an actual current supplied by the charger IC to charge the battery;
determining, by the BMS, a difference in the determined real time optimal current and the actual current supplied by the charger IC;
correcting, by the BMS, the at least one battery parameter based on the difference; and
storing, by the BMS, the present battery condition and the at least one corrected battery parameter in the memory.

3. The method as claimed in claim 1, wherein the present battery condition comprises at least one of a charge capacity of the battery, a temperature of the battery, or a voltage of the battery.

4. The method as claimed in claim 1, wherein the at least one battery parameter comprises at least one of a current, a temperature of the battery, State of Charge (SOC) of the battery, State of Health (SOH) of the battery, a charge capacity of the battery, a voltage of the battery, or tunable parameters.

5. The method as claimed in claim 2, wherein the BMS configures the charger IC to charge the battery based on the at least one corrected battery parameter, in response to correcting the at least one battery parameter in real time or periodically based on the difference.

6. A method to increase a life of a battery using real time adaptive charging, the method comprises:
receiving, by a Battery Management System (BMS), at least one battery parameter;
determining, by the BMS, a present battery condition;
correcting, by the BMS, the at least one battery parameter based on the present battery condition;
determining, by the BMS, a degradation state of the battery using a mathematical model;
determining, by the BMS, a real time optimal current used for charging the battery for reducing the determined degradation state; and
charging, by the BMS, the battery based on the determined real time optimal current for enhancing the life of the battery.

7. The method as claimed in claim 6, wherein the present battery condition comprises at least one of a charge capacity of the battery, a temperature of the battery, or a voltage of the battery.

8. The method as claimed in claim 6, wherein the at least one battery parameter comprises a current, a temperature of the battery, State of Charge (SOC) of the battery, State of Health (SOH) of the battery, a charge capacity of the battery, a voltage of the battery, and tunable parameters.

9. An electronic device for real time adaptive charging of a battery, the electronic device comprising:
a memory; and
a Battery Management System (BMS), coupled to the memory, configured to:
receive at least one battery parameter,
determine a present battery condition,
correct the at least one battery parameter based on the present battery condition,
determine a real time optimal current used for charging the battery based on the at least one corrected battery parameter,
charge the battery based on the determined real time optimal current, wherein the BMS configures a charger Integrated Circuit (IC) to charge the battery, and
update and store the at least one corrected battery parameter in real time in the memory after charging the battery at the determined real time optimal current.

10. The electronic device as claimed in claim 9, wherein the BMS is configured to:
obtain an actual current supplied by the charger IC to charge the battery;
determine a difference in the determined real time optimal current and the actual current supplied by the charger IC;
correct the at least one battery parameter based on the difference; and
store the present battery condition and the at least one corrected battery parameter in the memory.

11. The electronic device as claimed in claim 9, wherein the present battery condition comprises at least one of a charge capacity of the battery, a temperature of the battery, or a voltage of the battery.

12. The electronic device as claimed in claim 9, wherein the at least one battery parameter comprises at least one of a current, a temperature of the battery, State of Charge (SOC) of the battery, State of Health (SOH) of the battery, a charge capacity of the battery, a voltage of the battery, or tunable parameters.

13. The electronic device as claimed in claim 10, wherein the BMS configures the charger IC to charge the battery based on the at least one corrected battery parameter, in response to correcting the at least one battery parameter in real time or periodically based on the difference.

14. An electronic device to increase a life of a battery using real time adaptive charging, the electronic device comprising:
a memory; and
a Battery Management System (BMS), coupled to the memory, configured to:
receive at least one battery parameter,
determine a present battery condition,
correct the at least one battery parameter based on the present battery condition,
determine a degradation state of the battery using a mathematical model,
determine a real time optimal current used for charging the battery for reducing the determined degradation state, and
charge the battery based on the determined real time optimal current for enhancing the life of the battery.

15. The electronic device as claimed in claim 14, wherein the present battery condition comprises at least one of a charge capacity of the battery, a temperature of the battery, or a voltage of the battery.

16. The electronic device as claimed in claim 14, wherein the at least one battery parameter comprises at least one of a current, a temperature of the battery, State of Charge (SOC) of the battery, State of Health (SOH) of the battery, a charge capacity of the battery, a voltage of the battery, or tunable parameters.

17. The method as claimed in claim 3, wherein the charge capacity of the battery is based on a product of a reference charge capacity and a charge capacity correction factor.

18. The method as claimed in claim 7, wherein the charge capacity of the battery is based on a product of a reference charge capacity and a charge capacity correction factor.

19. The electronic device as claimed in claim 11, wherein the charge capacity of the battery is based on a product of a reference charge capacity and a charge capacity correction factor.

20. The electronic device as claimed in claim 15, wherein the charge capacity of the battery is based on a product of a reference charge capacity and a charge capacity correction factor.
